(19) United States
(12) Patent Application Publication
(10) Pub. No.: US 2013/0337702 A1
(43) Pub. Date: Dec. 19, 2013

(54) ELECTRICAL RECEPTACLE ASSEMBLY

(71) Applicant: Lear Corporation, Southfield, MI (US)

(72) Inventors: Slobodan Pavlovic, Novi, MI (US); Michael Glick, Farmington Hills, MI (US); Sheikh Habibur Rahman, Macomb, MI (US)

(21) Appl. No.: 13/919,395

(22) Filed: Jun. 17, 2013

Related U.S. Application Data
(60) Provisional application No. 61/661,407, filed on Jun. 19, 2012.

(51) Int. Cl. H01R 13/635; H01R 43/20

(52) U.S. Cl. CPC H01R 13/635; H01R 43/20
USPC 439/700; 29/876

(57) ABSTRACT

An electrical receptacle assembly is provided with a conductive body with a receptacle formed therein. At least one annular spacer is provided within the receptacle. At least one annular coil spring is provided in the receptacle, generally coaxial with the spacer, in electrical contact with the body for receipt of an electrical connector within the receptacle in contact with the coil spring. A method to assemble an electrical receptacle provides a conductive body with a receptacle formed therein. A quantity of contact coil springs and a location of the contact coil springs is determined. Spacers are selected based on the determined contact coil spring locations. The spacers and springs are inserted into the receptacle of the body.

### CROSS-REFERENCE TO RELATED APPLICATIONS

This application claims the benefit of U.S. provisional Application No. 61/661,407 filed Jun. 19, 2012, the disclosure of which is incorporated in its entirety by reference herein.

### TECHNICAL FIELD

Various embodiments relate to electrical receptacle assemblies.

### BACKGROUND

One example of an electrical connector for vehicle charging is disclosed in U.S. Pat. No. 7,878,866 B1 to Kwasny et al.

### SUMMARY

According to at least one embodiment, an electrical receptacle assembly is provided with a conductive body with a receptacle formed therein. At least one annular spacer is provided within the receptacle. At least one annular coil spring is provided in the receptacle, generally coaxial with the spacer, in electrical contact with the body for receipt of an electrical connector within the receptacle in contact with the coil spring.

According to at least one embodiment a vehicle charging system is provided with a cordset assembly to receive electrical energy. A connector assembly is sized to be received within a vehicle receptacle with at least one pin. The connector assembly is connected to the cordset assembly. An electrical receptacle assembly is provided oriented in the connector assembly and in electrical connection with the cordset assembly. The electrical receptacle assembly has a conductive body with a receptacle formed therein. At least one annular spacer is provided within the receptacle. At least one annular coil spring is provided in the receptacle, generally coaxial with the spacer, in electrical contact with the body for receipt of an electrical connector within the receptacle in contact with the coil spring. The electrical receptacle assembly provides an electrical connection with the at least one pin.

According to at least one embodiment, an electrical receptacle assembly is provided with a conductive body with a receptacle formed therein. At least one cylindrical spacer is provided within the receptacle. At least one annular coil spring is provided in the receptacle, generally coaxial with the spacer, in electrical contact with the body for receipt of an electrical connector within the receptacle in contact with the coil spring. An annular cap is mounted to a distal end of the body for retaining the at least one spacer and the at least one coil spring in the receptacle.

According to at least another embodiment, a method to assemble an electrical receptacle provides a conductive body with a receptacle formed therein. A quantity of contact coil springs and a location of the contact coil springs is determined. Spacers are selected based on the determined contact coil spring locations. The spacers and springs are inserted into the receptacle of the body.

### BRIEF DESCRIPTION OF THE DRAWINGS

FIG. 1 is a perspective view of a connector assembly according to an embodiment illustrated in cooperation with a vehicle and a power supply;

FIG. 2 is an exploded perspective view of the connector assembly of FIG. 1;

FIG. 3 is a partial section perspective view of an electrical terminal assembly of the connector assembly of FIG. 1, according to an embodiment, illustrated in cooperation with an electrical terminal received therein;

FIG. 4 is a side partial section view of the electrical terminal assembly and electrical terminal of FIG. 3;

FIG. 5 is a partial section perspective view of an electrical terminal assembly of the connector assembly of FIG. 1, according to another embodiment, illustrated in cooperation with the electrical terminal;

FIG. 6 is a side partial section view of the electrical terminal assembly and electrical terminal of FIG. 5;

FIG. 7 is a partial section perspective view of an electrical terminal assembly of the connector assembly of FIG. 1, according to another embodiment, illustrated in cooperation with the electrical terminal;

FIG. 8 is a side partial section view of the electrical terminal assembly and electrical terminal of FIG. 7; and

FIG. 9 is a side partial section view of an electrical terminal assembly of the connector assembly of FIG. 1, according to an embodiment, illustrated in cooperation with an electrical terminal received therein.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Electrical terminals are used in a number of applications to facilitate electrical connecting of one element to another. Some electrical terminals may be configured to facilitate use with a removable connector of the type that may be repeatedly inserted and removed or otherwise configured to repeatedly engage and disengage the electrical terminal. The ability of the electrical terminal to facilitate electrical connectivity with such a removable connector can be problematic if an electrical connection area between the terminal and connector has poor connectivity, particularly when tolerance variations or degradation from repeated use causes a mating arrangement between the components to become loose or otherwise insecure.

Charging systems operable to facilitate charging of a vehicle charging system with energy provided from a wall outlet or charging station are known in the art. Such systems may include a cordset having plurality of conducting wires and/or other conducting elements to facilitate delivering current between the charging station and the vehicle charging system. One end of the cordset may include a connector assembly configured to be received within a charging receptacle associated with the vehicle charging system. The connector assembly may be of the type described in U.S. Pat. No. 7,878,866 to Kwasny et al.

The charging receptacle may be configured to facilitate establishment of an electrical connection between a plurality of electrically conducting elements of the vehicle charging system and the charging station. The charging receptacle may facilitate the desired electrical connection by providing interconnecting conducting elements and/or by guiding the vehicle charging system and conducting elements of the connector assembly into a mating arrangement with each other. The charging receptacle may be configured to support a multiple pin or port connection methodology for facilitating electrically interconnecting the vehicle charging system and the conducting elements of the connector assembly, including, but not limited to, that specified in Society of Automotive Engineer (SAE) J1772 and International Electrotechnical Commission (IEC) 51851.

The connector assembly may be configured to facilitate electrically interconnecting vehicle charging system conducting elements with conducting elements of the cordset by guiding the elements into engagement with each other. The charging connector assembly may include a plurality of electrical terminal assemblies.

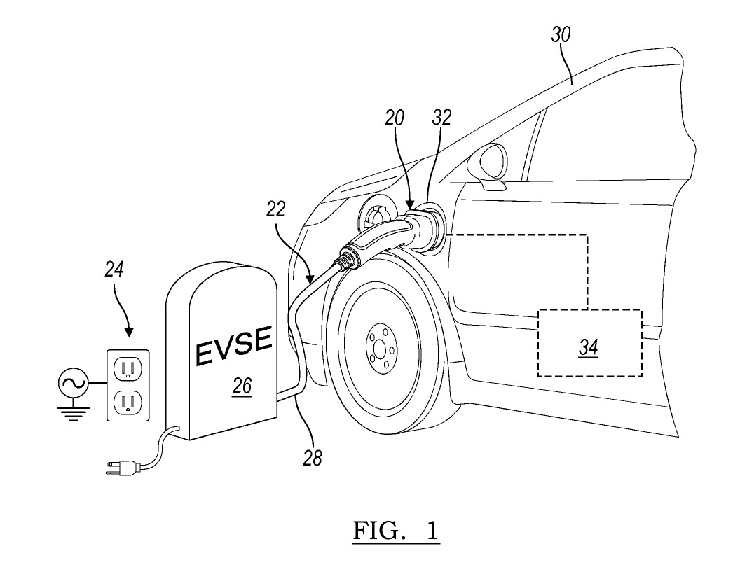

With reference to FIG. 1, a connector assembly for facilitating electric charging of a vehicle is illustrated in accordance with an embodiment and is referenced generally by numeral 20. In general, the connector assembly 20 is configured to accommodate a number of different electrical harness configurations by interchanging a couple components.

The connector assembly 20 is included in a cordset assembly 22, according to one or more embodiments. The cordset assembly 22 includes a connector for connecting to an external power supply 24 for receiving electrical energy. The external power supply 24 represents an alternating current (AC) electrical power supply, such as a standard residential power circuit. The cordset assembly 22 includes electric vehicle supply equipment (EVSE) 26 and a charging cable 28. The charging cable 28 extends between the EVSE 26 and the connector assembly 20. The EVSE 26 is configured to monitor electrical energy passing through the cable 28 during charging. The cordset assembly 22 may be configured to be portable (as shown in FIG. 1) or fixed to a charging station (not shown).

The connector assembly 20 attaches to a “plug-in” vehicle 30, such as a hybrid electric vehicle, for supplying electrical energy to the vehicle 30. The vehicle 30 includes a vehicle charging receptacle 32 that is connected to a battery 34 for receiving and storing electrical energy. The vehicle charging receptacle 32 is mounted to be externally accessible from the vehicle 30. The vehicle receptacle 32 receives the connector assembly 20. The battery 34 is electrically connected to the charging receptacle 32 for storing electrical power. The vehicle 30 may also include a converter (not shown) for converting AC to DC electrical power for storage in the battery 34. The vehicle 30 may be an electric vehicle, or any suitable vehicle that receives external electric power.

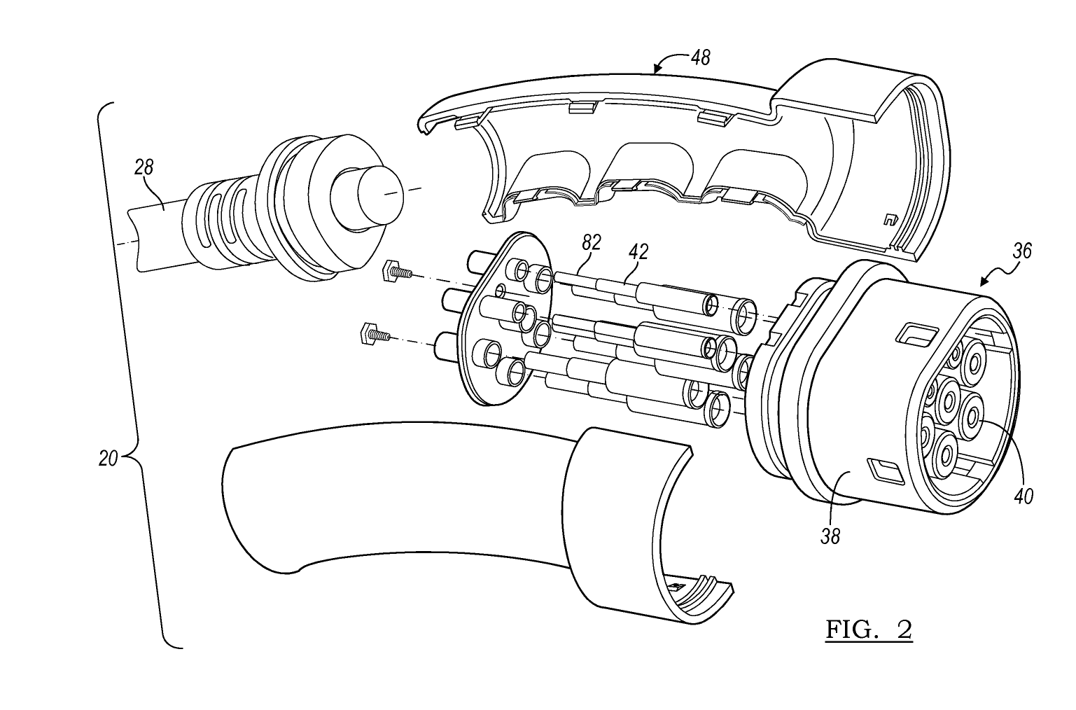

Referring now to FIG. 2, the connector assembly 20 is illustrated exploded for revealing the various components. The connector assembly 20 includes a receptacle housing portion 36 that has an external plug 38 that is sized to be received within the vehicle charging receptacle 32. The receptacle housing portion 36 includes a plurality of recessed sockets 40 that are each sized to receive an electrical connector, such as a receptacle assembly 42. The receptacle assemblies 42 are female electrical connectors that are inserted into the sockets 40 and retained into the sockets 40 by a backing plate 44 that is fastened to the receptacle housing portion 36 by fasteners 45.

The receptacle assemblies 42 receive a plurality of pins (not shown) that are recessed within the vehicle charging receptacle 32 as is known in the art. By inserting the plug 38 into the vehicle charging receptacle 32, the receptacle assemblies 42 are aligned with the pins and the pins are received within the sockets 40 and consequently the receptacle assemblies 42 making electrical connection between the cordset assembly 22 and the vehicle 30. Alternatively, the sockets 40 may retain male pin connectors. The connector assembly 20 includes a housing 48. Wires 82 extend from the cable 28, and are connected to the receptacle assemblies 42.

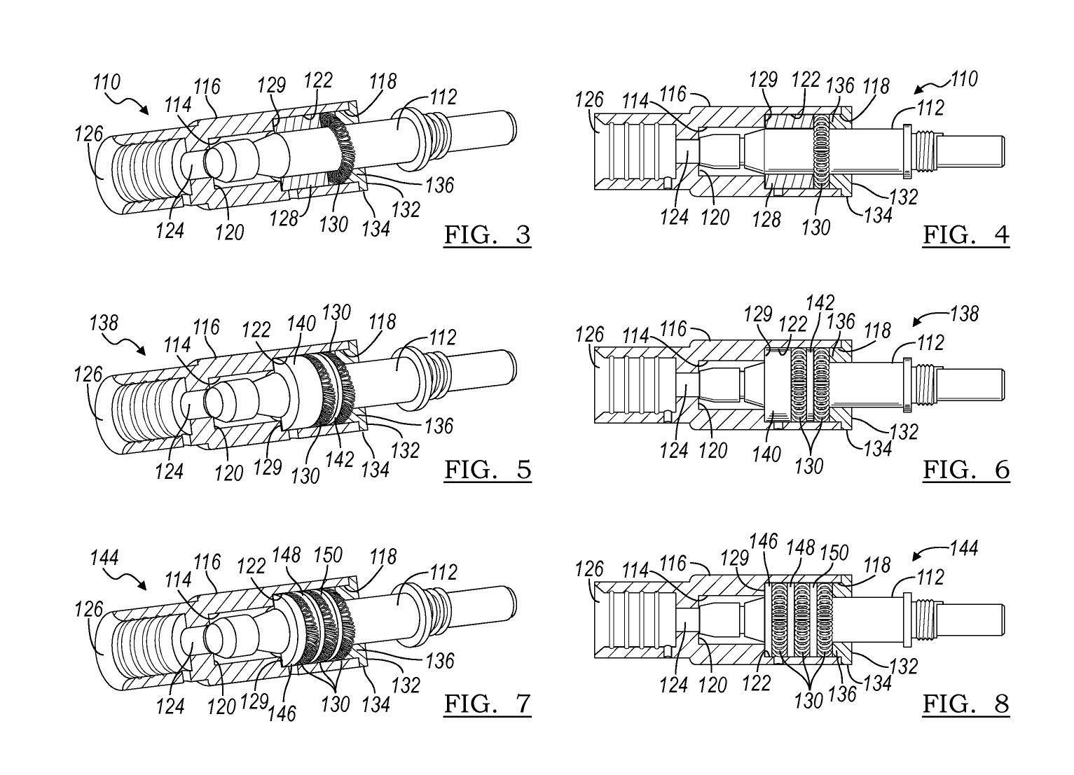

Referring to FIGS. 3 and 4, the electrical terminal assemblies may each be embodied by a receptacle assembly 110. The receptacle assembly 110 may be employed as the receptacle assembly 42 of the connector assembly 10 for receiving a pin 112 within a charging receptacle 114. The receptacle assembly 110 is configured to facilitate interconnecting of the pin 112 within the charging receptacle 114 with wires 82 included within the cordset assembly 22. The charging system and the particular components disclosed in FIGS. 1-4 are for example only and depict one embodiment for utilizing the receptacle assembly 110. Of course, the receptacle assemblies 110 may be employed at any electrical connection wherein a female receptacle receives a pin.

The receptacle assembly 110 is illustrated with a receptacle body 116. The receptacle body 116 may be similar to an embodiment disclosed in U.S. patent application publication number 2012/0282797 A1 filed on Aug. 22, 2011 by Mott et al. The receptacle body 116 has a bore or the receptacle 114 formed therein. The receptacle 114 has an opening 118 and a receptacle end 120. The receptacle end 120 has a diameter that is sized to provide clearance to the pin 112. The receptacle end 120 may have a blind depth according to an embodiment. Alternatively, as depicted, a through hole 124 may extend through the receptacle 114 into a socket 126 on an opposed side of the body 116. The socket 126 may be employed for connecting the receptacle assembly 110 to the cordset assembly 22. The receptacle body 116 may be generally hollow and cylindrical in shape. The body 116 may be formed of any suitable material, such as a conductive material that is adequately rigid. According to another embodiment, the receptacle body 116 may be insulated on its exterior.

The receptacle 114 has an enlarged region 122 with a diameter that is greater than the receptacle end 120. A spacer 128 is oriented within the enlarged region 122 to abut a depth 129 of the enlarged region 122. The spacer 128 may be formed of any suitable conductive or non-conductive material.

An electrically canted coil spring 130 is received within the receptacle 114 to act as a conductive terminal. In the depicted embodiment, the spring 130 contacts the receptacle 114 for providing an electrical connection between the spring 130 and the receptacle 114. The spring 130 is coiled about a circular axis in a toroidal configuration. An outside diameter of the spring 130 is oversized to maintain contact with the enlarged region 122. The spring 130 may be formed of an electrically conductive spring metal, such as a spring tempered alloy or a binary metal such as copper clad steel. The spring 130 also has an inside diameter that is smaller than the diameter of the pin 112 in order to maintain electrical contact with the pin 112 to provide electrical communication between the pin and the receptacle body 116.

The receptacle assembly 110 also includes a retainer 132 secured to the receptacle opening 18 for reducing a diameter of the receptacle opening 118. The retainer 132 may be similar to an embodiment disclosed in U.S. patent application publication number 2012/0282797 A1 filed on Aug. 22, 2011 by Mott et al. The retainer 132 may be insulated to prevent inadvertent electrical communication with the opening 118 of the receptacle body 116. The retainer 132 has a shoulder 134 abutting the opening 118. The retainer 132 also has a body 136 extending into the receptacle 114.

The retainer 132 and the spacer 128 collectively retain the spring 130 without requiring machining of the receptacle 114 which could add additional manufacturing costs. The retention of the spring 130 by the retainer 132 and the spacer 128 also prevents damage caused by deformation of the spring 130 within a rigid groove. Without a groove, assembly of the receptacle assembly 110 is simplified.

The spring 130 may be utilized in the connector assemblies 20 for vehicle charging systems. Such systems often employ high-voltage charging, which is most effective if contact of electrical connections is optimized. Additionally, such vehicle charging systems are exposed to harsh environments and undergo multiple mating cycles. The spring 130 improves contact of the receptacle body 116 with the spring 130 as well as contact of the spring 130 with the pin 112. These improved contacts improve the durability of the spring 130 and consequently the durability of the receptacle body 116 and the receptacle assembly 110.

For some cordset assemblies 22 with multiple pins 112 and multiple receptacle assemblies 110, the springs 130 of various receptacle assemblies 110 may be located at differing depths in order to vary the timing of the connections for controlling on-off engagements. Some embodiments may require a specific sequencing amongst the connections of various pin 112 and receptacle assembly 110 combinations. Some embodiments may require a specific sequencing of connections of one pin 112 to multiple springs 130 within a single receptacle body 116.

The prior art has addressed this product requirement by machining various recesses within the receptacle 114. The machining processes add manufacturing costs and create a receptacle body 116 that is specific for only one spring 130 quantity and depth configuration. Additionally, the assembly process of installing the springs 130 into the recesses is difficult, thereby increasing manufacturing costs due to cycle time. Even further, the springs 130 can be damaged due to unnecessary deformation during installation, particularly when installed into deep recesses. The spring 130 is an electrical component that under deflection maintains an even surface contact for power distribution. Uneven deflection, caused by damage to the spring 130 may result in poor power distribution.

If the prior art receptacle diameter is too small, the compression of the spring 130 to pass the receptacle diameter may damage the spring 130. If the prior art receptacle diameter is too large, then the groove for the spring 130 may be too shallow, thereby inadequately supporting the spring 130. Inadequate support of the spring 130 can lead to damage to the spring 130 and/or inadvertent removal of the spring 130 after various connection cycles with the pin 112. The inaccessibility of the recess-installed springs 130 are also difficult to access for maintenance and repair.

The use of the spacer 128 or any number of spacers and the retainer 132 overcomes the aforementioned shortcomings of the prior art. The receptacle diameter is sized at a dimension for optimal deflection of the springs 130 for electrical contact without plastic or permanent deformation of the springs 130. The spacer 128 and retainer 132 provide adequate axial support to the spring 130 or springs to retain the spring 130 and minimize unnecessary deflection of the spring 130.

The inner diameter of the spacer 128 is not dictated or limited as a function of spring 130 deflection, because the spring 130 does not need to pass through the spacer 128 during installation. Instead the spacer 128 has an inner diameter sized relative to the pin 112 only. Therefore the spacer 128 may include an inner diameter that is sized for alignment of the pin 112. The spacer 128 may formed of a conductive material for a connection with the pin 112 and the receptacle body 116. Alternatively, the spacer 128 may formed of an insulative material. The insulative materials lead to cheaper material costs and cheaper manufacturing processes for molding, while also reducing a weight of the receptacle assembly 110.

The design of the receptacle body 116 is versatile and universal for various receptacle assembly 110 designs. Moreover, various receptacle assemblies can be assembled from various combinations of spacers 128 and springs 130 with the receptacle body 116.

Another receptacle assembly 138 is illustrated in FIGS. 5 and 6. For increased capability to transfer high current, multiple canted coil springs 130 may be employed for additional contact with the pin 112. One spacer 140 is provided at the depth 129 of the enlarged region 122 of the receptacle 114. Another spacer 142 is provided in between the two springs 130. The springs 130 are separated to prevent the springs 130 from pinching or interfering during deformation caused by receipt of the pin 112. The springs 130 and spacers 140, 142 are retained within the enlarged region 122 of the receptacle 114 by a retainer 132. The spacers 140, 142 prevent machining multiple grooves; and adequately space the springs 130 each to the desired depth.

A three spring 130 receptacle assembly 144 is illustrated in FIGS. 7 and 8 with one spacer 146 at the depth 129 of the enlarged region 122 of the receptacle 114. Additional spacers 148, 150 are provided in between the springs 130.

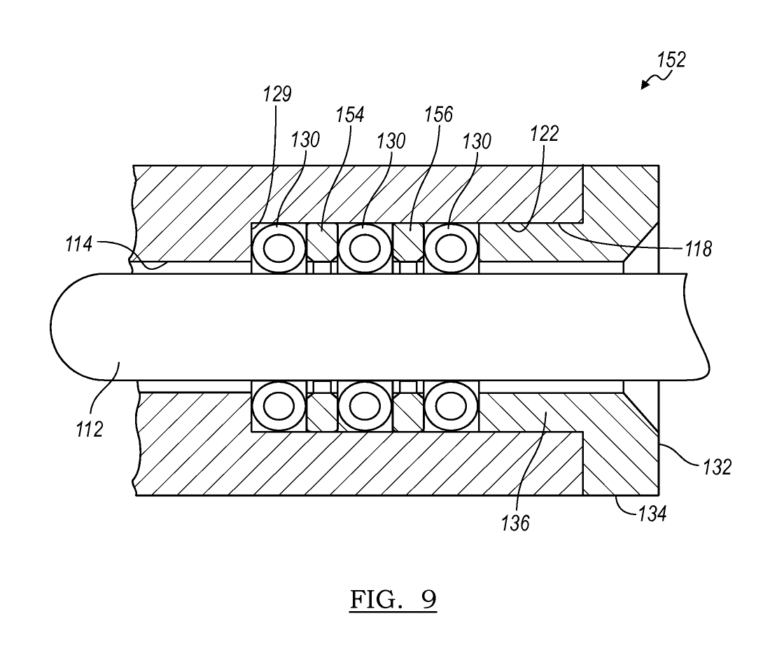

Another three spring 130 receptacle assembly 152 is illustrated in FIG. 9. One spring 130 is provided at the depth 129 of the enlarged region 122 of the receptacle 114. Two spacers 154, 156 are provided in between the springs 130.

Moreover, a modular set of components can provide various receptacle assembly 110, 138, 144, 152 combinations without requiring an additional manufacturing of components. By maintaining an inventory of receptacle bodies 116, springs 130, retainers 132, and spacers 128, 140, 142, 146, 148, 150, 154, 156 of varying incremental thicknesses, an adequate range of receptacle assemblies can be obtained that is not limited to the combinations 110, 138, 144, 152 described herein.

A modular assembly process for various electrical receptacle assemblies provides a conductive body with a receptacle formed therein. A quantity of contact coil springs and a location of the contact coil springs are determined based on an application specific, or product specific design. Spacers are selected based on the determined contact coil spring locations. The spacers and springs are inserted into the receptacle of the terminal body.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An electrical receptacle assembly comprising:
a conductive body with a receptacle formed therein;
at least one annular spacer provided within the receptacle; and
at least one annular coil spring provided in the receptacle, generally coaxial with the spacer, in electrical contact with the body for receipt of an electrical connector within the receptacle in contact with the coil spring.

2. The electrical receptacle assembly of claim 1 further comprising an annular cap mounted to a distal end of the body to retain the at least one spacer and the at least one coil spring in the receptacle.

3. The electrical receptacle assembly of claim 1 wherein the receptacle is generally cylindrical.

4. The electrical receptacle assembly of claim 1 wherein the receptacle has a common diameter at a region of the at least one spacer and the at least one coil spring.

5. The electrical receptacle assembly of claim 1 wherein the receptacle does not have any grooves formed therein in a region that includes the at least one coil spring.

6. The electrical receptacle assembly of claim 1 wherein the receptacle is sized to receive a pin for electrical contact with the at least one coil spring.

7. The electrical receptacle assembly of claim 1 wherein the at least one coil spring is toroidal about a circular axis.

8. The electrical receptacle assembly of claim 1 wherein the at least one coil spring has an inner diameter that is less than an inner diameter of the receptacle for electrical contact with a pin.

9. The electrical receptacle assembly of claim 1 wherein the at least one spacer is generally cylindrical.

10. The electrical receptacle assembly of claim 1 wherein the at least one spacer has an outer diameter that is less than an inner diameter of the receptacle, and wherein the at least one spacer has an inner diameter that is sized for alignment of a pin.

11. The electrical receptacle assembly of claim 1 wherein the at least one spacer is formed from an insulative material.

12. The electrical receptacle assembly of claim 1 wherein the at least one annular coil spring comprises at least two annular coil springs with the at least one spacer oriented between the at least two annular coil springs.

13. The electrical receptacle assembly of claim 1 wherein the at least one annular spacer comprises at least two annular spacers; and
wherein the at least one annular coil spring comprises at least three annular coil springs with each of the at least two spacers oriented between a sequential pair of the at least three annular coil springs.

14. A vehicle charging system comprising:
a cordset assembly to receive electrical energy;
a connector assembly sized to be received within a vehicle receptacle with at least one pin, the connector assembly being connected to the cordset assembly; and
at least one electrical receptacle assembly according to claim 1, oriented in the connector assembly in electrical connection with the cordset assembly for electrical connection with the at least one pin.

15. The electrical receptacle assembly of claim 1 wherein the receptacle includes an enlarged region that is sized to receive the at least one spacer and the at least one coil spring.

16. The electrical receptacle assembly of claim 15 wherein the at least one coil spring has an outer diameter that is greater than an inner diameter of the enlarged region to maintain electrical contact with the body.

17. An electrical receptacle assembly comprising:
a conductive body with a receptacle formed therein;
at least one cylindrical spacer provided within the receptacle;
at least one annular coil spring provided in the receptacle, generally coaxial with the spacer, in electrical contact with the body for receipt of an electrical connector within the receptacle in contact with the coil spring; and
an annular cap mounted to a distal end of the body to retain the at least one spacer and the at least one coil spring in the receptacle.

18. The electrical receptacle assembly of claim 17 wherein the receptacle does not have any grooves formed therein in a region that includes the at least one coil spring.

19. A method to assemble an electrical receptacle comprising:
providing a conductive body with a receptacle formed therein;
determining a quantity of contact coil springs and a location of the contact coil springs;
selecting spacers based on determined contact coil spring locations; and
inserting the spacers and springs into the receptacle of the body.

20. The method of claim 19 further comprising a step of forming the receptacle without any grooves formed therein.
